(19) United States
(12) Patent Application Publication
(10) Pub. No.: US 2008/0065664 A1
(43) Pub. Date: Mar. 13, 2008

(54) COMPUTER-IMPLEMENTED METHOD, TOOL, AND PROGRAM PRODUCT FOR MORE EFFICIENTLY UTILIZING JAVA RESOURCE BUNDLES

(76) Inventors: Daniel B. Kehn, Cary, NC (US); Johannes C. Laffra, Raleigh, NC (US); Jeffrey A. McAffer, Ottawa (CA)

Correspondence Address: HOFFMAN WARNICK & DALESSANDRO LLC, 75 STATE ST, 14TH FLOOR, ALBANY, NY, 12207, US

(21) Appl. No.: 11/426,747

(22) Filed: Jun. 27, 2006

(51) Int. Cl. G06F 7/00

(52) U.S. Cl. 707/101

(57) ABSTRACT

A method, system, tool, and program product for more efficiently utilizing Java property resource bundles. Specifically, under the present invention, the string key of a resource bundle is changed to allow it to take up less space in memory. This may be accomplished by converting the key values from string type to integer type values. In the alternative, this may be accomplished by converting the entire property resource bundle to a Java class. This conversion may occur during design time or, in the alternative, may happen at run time of an application that is to access the Java property resource bundle. The conversion of the resource bundle to a class eliminates the run-time errors due to the Java run-time environment's ability to determine the existence of required values. This conversion further improves memory utilization by removing the string keys.

### FIELD OF THE INVENTION

The present invention generally relates to using of an outside data source by a Java™ program. Specifically, the present invention provides a more efficient way of using Java property resource bundles.

### BACKGROUND OF THE INVENTION

As the field of computer programming evolves, many different computer systems that run many different operating platforms continue to be developed. Java provides a programming language that allows any platform to run a single application. One strength of an application written in Java is the ability to import data from files that are external to the Java application. One type of these data files, called a property resource bundle, stores a key and a data value that is associated with the key. Property resource bundles provide more flexibility to a particular Java application by allowing different property resource bundles to be packaged with the same Java application and by allowing the Java application to access more than one property resource bundle and/or giving the user the opportunity to choose among them. For example, an entry in a property resource bundle named MyResource_en.properties for use in an English language environment may include the entry:

greeting=Hello, how are you?

whereas an entry in a property resource bundle named MyResource_fr.properties for use in a French language environment may include the entry:

greeting=Comment allez-vous?

### As such, property resource bundles are especially adapted for storing a set of localized language words and phrases that allow the same Java application to be used in multiple language environments.

There are currently a number of disadvantages, however, in working with property resource bundles. First, when a Java application makes a call to an entry of the property resource bundle, Java reads the entire property resource bundle into an in-memory hash table. This causes inefficiency in retrieval time and storage space in the case that one or a few entries are needed from a property resource bundle with a large number of entries. Further, because the identifier for each piece of data in the property resource bundle is a string, the identifier itself, notwithstanding the data, uses a large amount of storage. This storage gluttony is exacerbated by the fact that there may be multiple entries in the hash table, with each entry having a multiple character string identifier.

Yet another drawback is the fact that the Java application only determines whether an entry in a property resource bundle is present after the entry is called by the program. This condition may result in errors long after a program has been created and shipped to a particular market. This condition may also discourage developers from removing a previously included entry from the property resource bundle upon removal of a reference from the program itself, for fear that the entry is used elsewhere, and removing it could result in errors.

In view of the foregoing there exists a need for improvements in using Java property resource bundles.

### SUMMARY OF THE INVENTION

In general, the present invention provides a method, system, tool, and program product for more efficiently utilizing Java property resource bundles. Specifically, under the present invention, the string key of a resource bundle is changed to allow it to take up less space in memory. This may be accomplished by converting the key values from string type to integer type values. In the alternative, this may be accomplished by converting the entire property resource bundle to a Java class. This conversion may occur during design time or, in the alternative, may happen at run time of an application that is to access the Java property resource bundle. The conversion of the resource bundle to a class eliminates the run-time errors due to the Java run-time environment's ability to determine the existence of required values. In addition, the conversion of the properties file to a class file improves memory utilization by removing the string keys.

A first aspect of the present invention provides a method for more efficiently retrieving data, comprising: providing a property resource bundle having at least one entry, each entry having a key in a string format and data; and converting the key from the string format into a space saving format, wherein the space saving format requires less space to store than the string format.

A second aspect of the present invention provides a system for more efficiently retrieving data, comprising: a resource bundle provider for providing a property resource bundle having at least one entry, each entry having a key in a string format and data; and a resource bundle converter for converting the key into a format that requires less space to store than a string.

A third aspect of the present invention provides a program product stored on a computer readable medium for more efficiently retrieving data, the computer readable medium comprising program code for causing a computer system to perform the following steps: provide a property resource bundle having at least one entry, each entry having a key in a string format and data; and convert the key into a format that requires less space to store than a string.

A fourth aspect of the present invention provides a method for deploying an application for more efficiently retrieving data, comprising: providing a computer infrastructure being operable to: provide a property resource bundle having at least one entry, each entry having a key in a string format and data; and convert the key from the string format into a space saving format, wherein the space saving format requires less space to store than the string format.

A fifth aspect of the present invention provides computer software embodied in a propagated signal for more efficiently retrieving data, the computer software comprising instructions for causing a computer system to perform the following steps: provide a property resource bundle having at least one entry, each entry having a key in a string format and data; and convert the key from the string format into a space saving format, wherein the space saving format requires less space to store than the string format.

Therefore, the present invention provides a computer-implemented method, tool, and program product for more efficiently retrieving data.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for more efficiently retrieving data according to the present invention.

FIG. 2 shows an illustrative diagram of an application retrieving a value from at least one property resource bundle.

FIG. 3 shows a conversion of a property resource bundle to a class file according to one embodiment of the claimed invention.

FIG. 4 shows a conversion of a property resource bundle in which the key is converted to an integer according to one embodiment of the claimed invention.

FIG. 5 shows a run time converter converting a property resource bundle at runtime of an application.

FIG. 6 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

As indicated above, the present invention provides a method, system, tool, and program product for more efficiently utilizing Java property resource bundles. Specifically, under the present invention, the string key of a resource bundle is changed to allow it to take up less space in memory. This may be accomplished by converting the key values from string type to integer type values. In the alternative, this may be accomplished by converting the entire property resource bundle to a Java class. This conversion may occur during design time or, in the alternative, may happen at run time of an application that is to access the Java property resource bundle. The conversion of the resource bundle to a class eliminates the run-time errors due to the Java run-time environment's ability to determine the existence of required values. In addition, the conversion of the properties file to a class file improves memory utilization by removing the string keys.

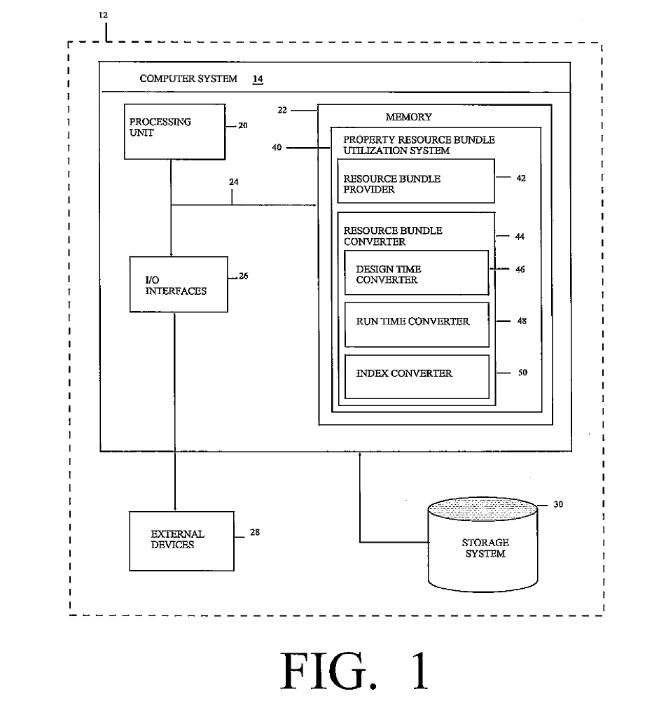

Referring now to FIG. 1, a system 10 for more efficiently utilizing Java property resource bundles according to the present invention is shown. Specifically, FIG. 1 depicts a system 10 in which a Java property resource bundle may be more efficiently utilized by converting the key from the string format to a less memory intensive one. In addition, system 10 may convert the entire property resource bundle into a Java class file. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to provide automatic replies to instant messages.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as a property resource bundle utilization system 40 and/or a Java application (not shown), which may be stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, Java Virtual Machine, math coprocessor, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as Java applications, property resource bundles, Java classes, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is property resource bundle utilization system 40, which is a software program that will provide the functions of the present invention, and which includes a resource bundle provider 42, and a resource bundle converter 44. Resource bundle converter 44, in turn, may include one or more of a design time converter 46, a run time converter 48 and an index converter 50. Also included, but not shown, in memory 22 may be a Java application, which may include a static initializer for checking the converted property resource bundles, as described in more detail below.

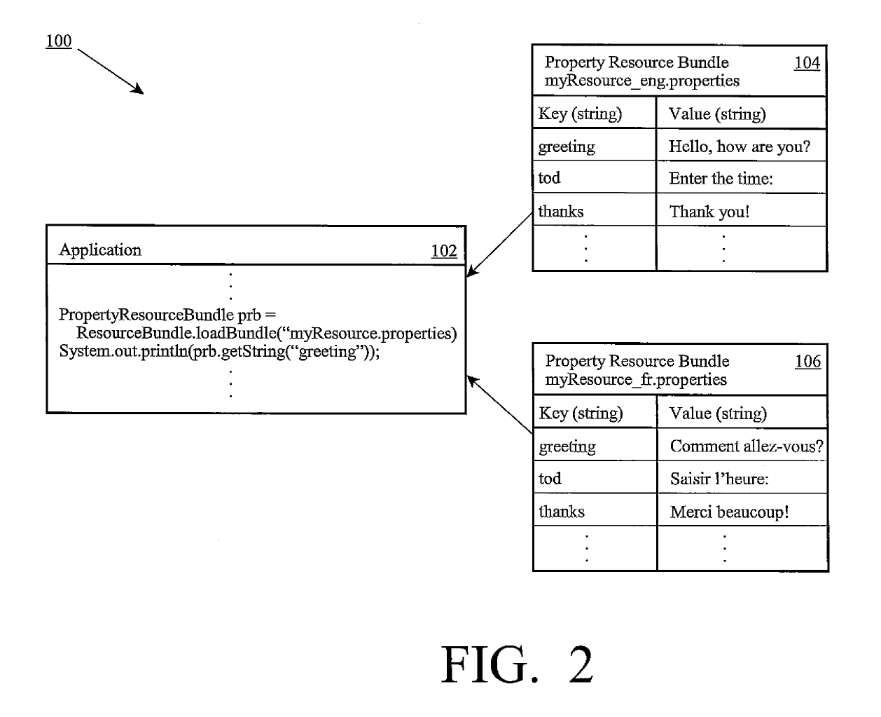

Referring now to FIGS. 1 and 2, collectively, resource bundle provider 42 of property resource bundle utilization system 40 will be described in more detail. In summary, resource bundle provider 42 provides a property resource bundle to be more efficiently utilized. As shown in FIG. 2, each property resource bundle 104, 106 has at least one entry. Each entry in a property resource bundle has a key that is in a string format and at least one data value. Property resource bundle 104, 106 may be adapted for use in a Java application, such as in application that is designed to choose one of a number of different languages, or in any other application that utilizes data of this type. Resource bundle provider 42 may include a data input apparatus for allowing a user to input the data in property resource bundle 104, 106. In the alternative, property resource bundle 104, 106 may be retrieved from an external source, such as storage system 30 and/or member 22.

In any event, resource bundle provider 42 provides property resource bundle 104, 106 to be converted by resource bundle converter 44. Resource bundle converter 44 converts the key of property resource bundle 104, 106 from the string format into a space saving format. This space saving format better utilizes system resources by requiring less space to store than the string format. In performing its task, resource bundle converter 44 may utilize one or more of design time converter 46, run time converter 48 and index converter 50.

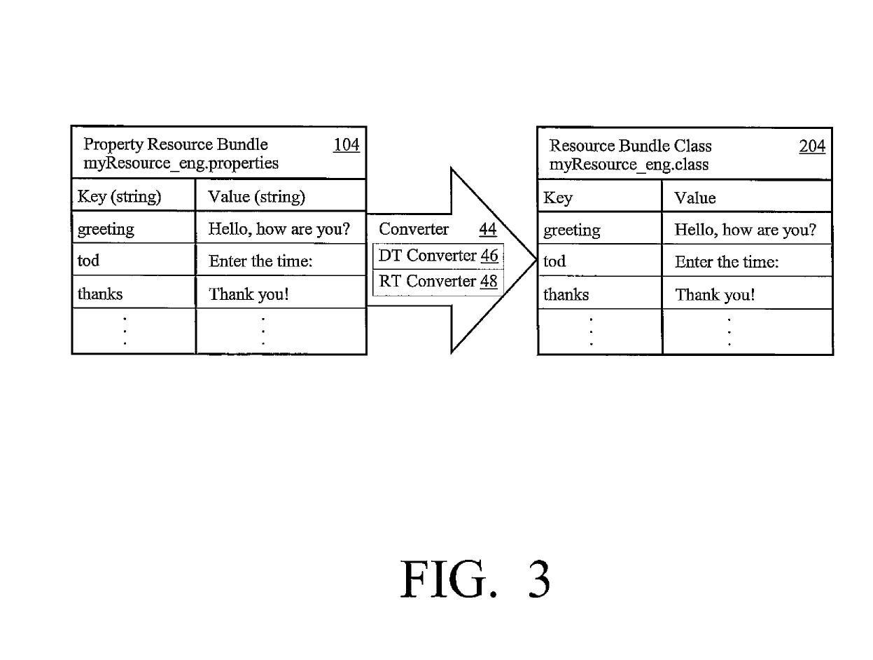

Referring now to FIGS. 1 and 3, concurrently, design time converter 46 of resource bundle 44 allows property resource bundle 104 to be converted as part of the design of an application 102 (FIG. 2). For example, design time converter 46 may convert property resource bundle 104 that has been designed to work in conjunction with application 102 to a new resource bundle class 204 in a Java class format. The conversion to the Java class format of resource bundle class 204 may automatically convert the keys of property resource bundle 104 that are in a string format into keys that are in a Java class key format. This new format of the keys in resource bundle class 204 provides a significant storage savings over the string key format of property resource bundle 104, from which conversion was made. In addition, rather than application 102 having to retrieve the entire file to access an entry, as is necessary with property resource bundle 104, application 102 can retrieve a single entry of resource bundle class 204, as needed. In addition, the conversion of property resource bundle 104 into a Java class allows resource bundle class 204 to be automatically loaded and checked for correct data by the static initializer of the Java class, which helps to reduce run time errors.

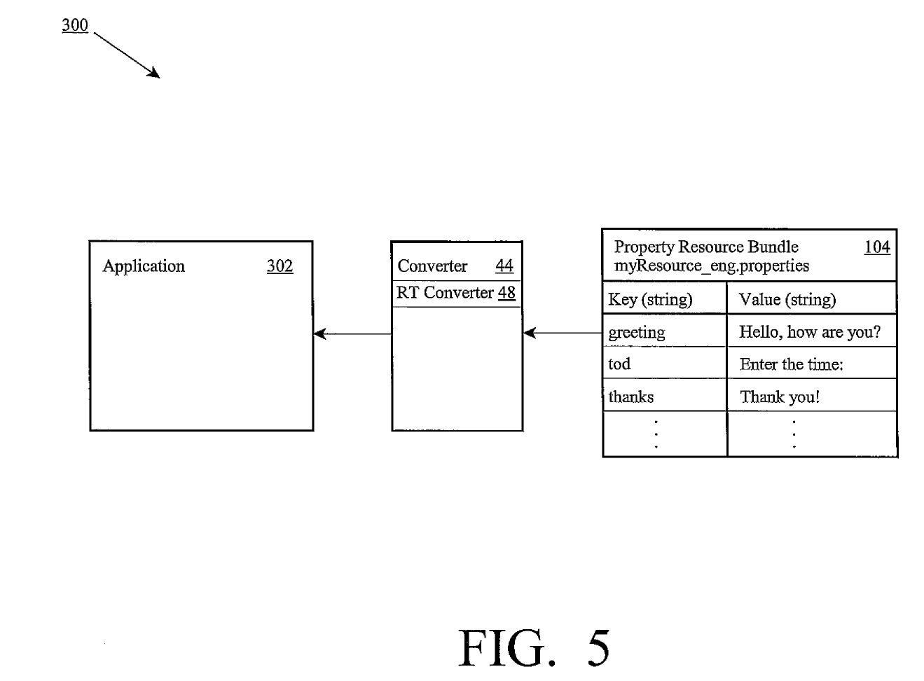

Referring now to FIGS. 1, 3 and 5 concurrently, run time converter 46 of resource bundle converter 44, similar to design time converter 46, converts property resource bundle 104 to resource bundle class 204 in a Java class format. However, in contrast to design time converter 46, the converting performed by run time converter 48 occurs at runtime of application 302. To this extent, an environment 300 containing application 302 to be run includes property resource bundle 104 with key field in a string format. Bundle 300 also includes run time converter 48 of resource bundle converter 44. Upon execution of application 302, run time converter 48 converts property resource bundle 104 into resource bundle class 304, which again converts the key into a space saving format. This conversion may be performed by reading property resource bundle 104 into application 302 and then writing property resource bundle 104 into a pre-defined class (not shown) using reflection or a similar technique. In addition or in the alternative, run time converter 48 may pre-bind the data included in resource bundle class into the code of application 302 that is retrieving the data. This pre-binding allows a greater amount of efficiency by allowing the code to be optimized. In addition, only the data values that are needed from resource bundle class are included, providing a more efficient use of space.

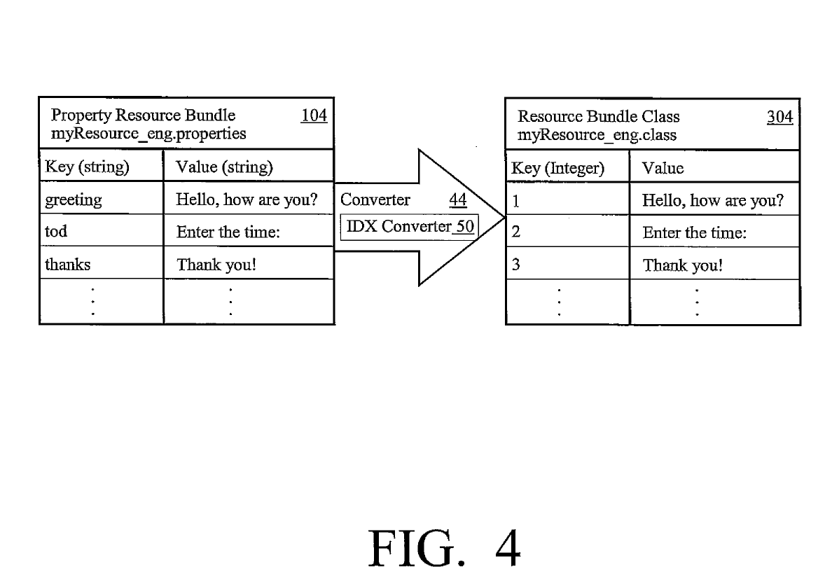

Referring now to FIGS. 1 and 4, concurrently, index converter 50 of resource bundle converter 44 more efficiently utilizes property resource bundle 104 by converting the key values into integers. This conversion allows the converted property resource bundle 304 to be accessed in an array data structure upon loading, rather than a heap data structure that is normally used for property resource bundle 104. The conversion performed by index converter 50 may be accomplished by subjecting property resource bundle 104 to conversion, changing each key value to an integer. Index converter 50 then may create a table that contains a mapping of the string value to the appropriate integer key value of the converted table. The code of application 102 (FIG. 2) may then be automatically modified by index converter 50 to replace the string values with the corresponding integer value from the table. This modification of code of application 102 may be performed prior to compilation (e.g., replacing portions of the source code), during compilation (such as by associating the identifier string in the code with the integer index), and/or during runtime. In addition, the conversion performed by index converter 50 may be performed in conjunction with conversion of property resource bundle 104 into resource bundle class 204, as performed by either design time converter 46 or run time converter 48.

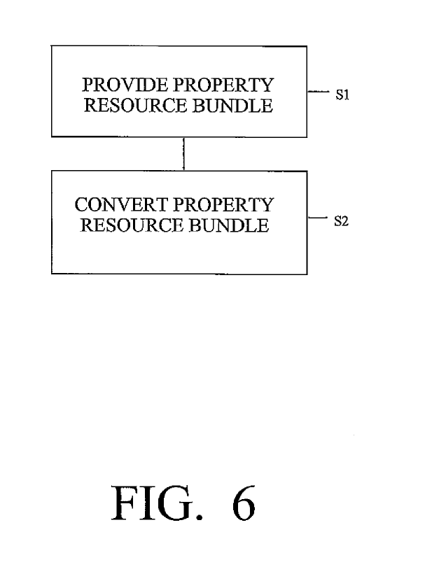

Turning now to FIG. 6, a flow chart of a method according to one embodiment of the present invention is depicted. FIG. 6 will be described with reference to FIGS. 1 and 3. In first step S1, resource bundle provider 42 provides a property resource bundle 104. As stated herein, property resource bundle 104 may be provided via user input or in an alternate way, such as by retrieving property resource bundle 104 from storage system 30. As stated above, property resource bundle 104 includes at least one entry, and each entry has data and a key in a string format.

Finally, in step S2, property resource bundle 104 is converted. This conversion converts the key of property resource bundle 104 from the string format into a space saving format. This space saving format to which the key is converted requires less space to store than original string format. The space saving format may be an integer and/or may be in the format of a key in a Java class. To this extent, the converting of property resource bundle 104 include conversion to a Java class file 204, during design time using design time converter 46 or during run time of application 302 using run time converter 48. Alternatively or in addition, the converting of property resource bundle may convert the key into an integer format by performing index mapping using index converter 50. This converting allows data from property resource bundle 104 to be more efficiently retrieved and/or utilized by a Java application.

While shown and described herein as a method and system for more efficiently utilizing a Java property resource bundle, it is understood that the invention further provides various alternative embodiments. For example, in one embodiment, the invention provides a computer-readable/useable medium that includes computer program code to enable a computer infrastructure to more efficiently utilizing a Java property resource bundle. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer a more efficient Java property resource bundle utilization service. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for more efficiently utilizing a Java property resource bundle. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. For example, design time converter 46, design time converter 48 and index converter 50, shown in FIG. 1 as part of resource bundle converter 44, may instead be separate systems. Such modifications and variations that may be apparent to a person skilled in the art are intended to be included within the scope of the invention as defined by the accompanying claims.

We claim:

1. A method for more efficiently retrieving data, comprising:
providing a property resource bundle having at least one entry, each entry having a key in a string format and data; and
converting the key from the string format into a space saving format,
wherein the space saving format requires less space to store than the string format.

2. The method of claim 1, wherein the format is integer.

3. The method of claim 1, wherein the data is retrieved by a Java application.

4. The method of claim 1, wherein the converting is performed by transforming the property resource bundle into a Java class.

5. The method of claim 4, wherein the Java class is automatically loaded and checked for correct data by a static initializer of the Java class.

6. The method of claim 4, wherein the converting occurs at runtime of an application.

7. The method of claim 6, wherein the converting pre-binds the data into program code that is retrieving the data.

8. A system for more efficiently retrieving data, comprising:
a resource bundle provider for providing a property resource bundle having at least one entry, each entry having a key in a string format and data; and
a resource bundle converter for converting the key into a format that requires less space to store than a string.

9. The system of claim 8, further comprising an index converter for converting the key into an integer format.

10. The system of claim 8, further comprising a Java application for retrieving the data.

11. The system of claim 8, wherein the resource bundle converter further comprises at least one of a design time converter and a run time converter for performing the conversion by transforming the property resource bundle into a Java class.

12. The system of claim 8, wherein the Java class is automatically loaded and checked for correct data by a static initializer of the Java class.

13. The method of claim 11, wherein the converting is performed by the run time converter that converts the property resource bundle at runtime of an application.

14. The method of claim 13, wherein the run time converter pre-binds the data into code of an application that is retrieving the data.

15. A program product stored on a computer readable medium for more efficiently retrieving data, the computer readable medium comprising program code for causing a computer system to perform the following steps:
provide a property resource bundle having at least one entry, each entry having a key in a string format and data; and
convert the key into a format that requires less space to store than a string.
